(19) United States
(12) Patent Application Publication
(10) Pub. No.: US 2013/0166344 A1
(43) Pub. Date: Jun. 27, 2013

(54) METHOD FOR PLANNING A PROCESS CHAIN FOR A AGRICULTURAL OPERATION

(71) Applicant: CLAAS Selbstfahrende Emtemaschinen GmbH, Harsewinkel (DE)

(72) Inventors: HANS-PETER GROTHAUS, BIELEFELD (DE); JOCHEN HUSTER, GUETERSLOH (DE); MAX REINECKE, VERSMOLD (DE); THILO STECKEL, GUETERSLOH (DE)

(73) Assignee: CLAAS Selbstfahrende Emtemaschinen GmbH, Harsewinkel (DE)

(21) Appl. No.: 13/709,184

(22) Filed: Dec. 10, 2012

(30) Foreign Application Priority Data
Dec. 15, 2011 (DE) 10 2011 088 700.8

(51) Int. Cl. G06Q 50/02

(52) U.S. Cl. CPC G06Q 50/02; G06Q 10/06313
USPC 705/7.23

(57) ABSTRACT

A method for planning a process chain for an agricultural operation having a first resource entity of a first type such as harvesting machines and a second resource entity of a second type such as hauling vehicles includes determining a number of machines of the first and second resource entity to be used in the operation depending on the usage time frame and type of operation, determining a plurality of alternative first partial process chains for the first resource entity, determining a second partial process chain for the second resource entity for each of the alternative first partial process chains, combining the alternative first partial process chains with the second partial process chain to form a plurality of total process chains and selecting one of the total process chains.

### CROSS-REFERENCE TO A RELATED APPLICATION

The invention described and claimed hereinbelow is also described in German Patent Application DE 10 2011 088 700.8 filed on Dec. 15, 2011. This German Patent Application, subject matter of which is incorporated herein by reference, provides the basis for a claim of priority of invention under 35 U.S.C. 119(a)-(d).

### BACKGROUND OF THE INVENTION

The invention relates to a method for planning a process chain for an agricultural operation and an arrangement for carrying out the method.

An agricultural operation is understood to be a harvesting procedure, for example, in which a field area is harvested and the crop is transported to a storage facility or a silo. An agricultural operation also can involve depositing fertilizer or seeds on a field area.

A process chain for such an agricultural operation works with a first resource entity of a first type of agricultural machines. The machines of the first resource entity are preferably harvesting machines, more particularly, self-propelled harvesting machines such as combine harvesters or forage harvesters. The machines of the first resource entity also can be machines that apply fertilizer or seeds, for example, or combinations of pulling vehicles such as tractors and attachments. The machines of the second resource entity are preferably so-called service machines that support the machines of the first resource entity. Such service machines can be hauling vehicles, for example, such as transfer vehicles for hauling the crop away, road hauling vehicles or vehicles comprising a reservoir for fertilizer or seeds, for example, to refill the machines of the first resource entity that apply fertilizer or seeds.

In addition to such mobile resources, a resource entity, more particularly the second or, optionally, a third or further resource entity, also can include immobile or semi-mobile resources such as silos, storage areas or containers.

To process large field areas, it is typical to use a plurality of machines of the first resource entity as well as the second resource entity or even a third or further resource entity. A plurality of combine harvesters (first resource entity) is used to harvest a field, for example, the grain tanks of which are unloaded several times by transfer vehicles (second resource entity) during the harvesting operation. The transfer vehicles transfer the crop to road hauling vehicles (third resource entity), which bring the crop to a storage facility or silo (fourth resource entity), for example.

A complex interplay of the different types of machines in a process chain is very significant in terms of the success of an agricultural operation. Methods have therefore developed for planning such process chains for an agricultural operation.

Document DE 10 2004 027 242 A1 relates to a route planning system for agricultural working machines, wherein a defined working width is assigned to the agricultural working machine and a driving route that accounts for the working width is planned and can be adapted to changing external conditions such as driving around obstacles.

Document EP 1 633 105 A1 discloses a system for collecting information, more particularly, situation-based process and planning data, to enable an agricultural working machine to carry out processes.

Document DE 10 2006 044 730 A1 describes a method for controlling and monitoring a process chain stored in a memory, in which the total process chain to be controlled and monitored is depicted on a display device, in an agricultural machine, for example. Such display enables a user to maintain an overview of the total process chain and to control and monitor the process.

Document DE 10 2006 015 204 A1 describes a method for creating a route plan for a group of agricultural machine systems, wherein a route plan for a territory to be worked can be created via the interaction of the machine systems.

Document DE 10 2008 021 785 A1 relates to a method and a device for coordinating a procedure to process an agricultural area that creates a route plan for a plurality of vehicles, at least one processing vehicle and at least one hauling vehicle.

Document EP 2 146 307 A2 describes a method for coordinating a plurality of driveable agricultural machines that share the use of at least one resource. The method enables all machines to be operated at optimal capacity.

Document WO 2011/104085 A1 describes a method for monitoring and coordinating harvesting processes, in which the fill levels and filling rates of the grain tanks are determined by harvesting machines and, on the basis thereof, tank-unloading processes are planned in order to reach a predetermined grain tank capacity.

Document DE 10 2008 050 460 A1 describes a method for controlling a usage of driveable agricultural machines on an area using a plurality of steps. In the method, determinations made in a preceding step are refined in the subsequent planning steps and, if a significant deviation from the determinations that were made occurs during the operation, then at least one of the planning steps is repeated.

Such known systems and methods, however, still are unable to optimize a total process chain according to various criteria and/or to more quickly react to changing conditions during operation.

### SUMMARY OF THE INVENTION

The present invention overcomes the shortcomings of the known arts, such as those mentioned above.

The present invention provides a method and an arrangement for planning a process chain for an agricultural operation comprising a first resource entity of a first type of agricultural machines and a second resource entity of a second type of agricultural machines, which at least partially satisfy one or more of the aforementioned needs.

The invention is based on the finding, inter alia, that a hierarchical structure of existing planning methods can result in disadvantages in planning and in suboptimal planning results. When planning is hierarchical, determinations that are made are refined in the subsequent steps, or further determinations are made on the basis thereof. If a subsequent step does not provide a solution or if basic conditions have changed, planning can be restarted at a certain step, once more in a hierarchical manner. Suboptimal total process chains often occur nevertheless in hierarchical planning methods, and result in waiting periods, increased wear or increased fuel consumption, for example, and therefore the possibility exists to further improve the productivity of the process chain overall.

Such suboptimal situations occur to an increasing extent when conditions change during the agricultural operation, such as the unexpected appearance of obstacles on a driving path, sudden weather changes or changes in the crop properties. Such sudden changes can affect the points in time at which the grain tank of a harvesting vehicle must be emptied.

In one aspect, the invention is based on the finding, inter alia, that, in subsequent steps, the determination made in a previous step rules out a plurality of possible solutions of this subsequent planning step. The explanation for the ruling-out can be based various reasons or conditions, for example: interactions of agricultural machines of the same type or, more particularly, different types involve technical relationships that render certain combinations impossible. For a grain tank unloading process, for example, the harvesting machine and the transfer vehicle must travel in parallel and close to one another at the same speed for a certain period of time. In the harvesting process in particular, the work carried out by harvesting machines results in possible paths for the service vehicles, or, during sowing, regions that have already been worked by the sowing machines may now be off-limits to the service vehicle. Other reasons can result from the (field) geometry, for example if travel must take place only in a certain direction due to a slope.

The inventive method makes it possible to consider a plurality of solutions, more particularly, in subsequent planning steps, while adhering to the basic technical and (field-) geometric conditions, to thereby arrive at a better coordinated total process chain.

In the solution, static preplanning is a starting point that is built upon. Static preplanning comprises, at the least, determining how many machines of which type should be used, which is dependent upon the area to be worked and on the usage time frame, that is, the time that is available for the operation, as well as on the type of work operation.

Hierarchical planning of the type carried out in existing planning methods is abandoned and, instead, a solution space is determined. The solution space comprises a plurality of various possible total process chains that are composed of first and second and possibly third and further partial process chains.

The problem that, in hierarchical planning, a determination is made in a previous planning step that rules out a plurality of possibilities in subsequent planning steps, is solved in this manner.

For the machines of the first resource entity, the method does not make a determination for a single solution, but rather determines a plurality of possible first partial process chains. If the first resource entity comprises harvesting machines, for example, a plurality of possible partial process chains for the harvesting machines is first determined.

The specifications or input quantities, according to which the plurality of first partial process chains is determined, relate, for example, to the field geometry (outer field limits, obstacles on the field or on access paths, the position and nature of access paths and field access points, requirements for soil conservation/compression, drilling direction, crop properties, etc.), basic technical data (machine parameters of the machines that are used), external information (such as weather data) or sensor data from the resources (for example, the particular position of the machines, crop properties). The specifications or input quantities also are used to ensure that no solutions are generated that cannot be implemented due to basic technical conditions of the machine or due to the geometry of the field and access paths, for example.

As a result, a first partial process chain built upon these specifications contains, in particular, interlinked driving tracks for each machine, specifications for the time-dependent position of the machines. In addition, information on the location-time points for necessary interactions with other machines, in particular, another resource entity, are preferably determined, for example, positions of the transfer windows that must be reached by a transfer vehicle in order to unload a harvesting vehicle. To determine the first partial process chains, a search graph can be generated, for example, in which a preferred direction is generated on the basis of heuristics.

A plurality of various possible solutions for working an area using agricultural machines therefore results, all according to the same specifications, and so, in this step, a plurality of alternative first partial process chains for the first resource entity is generated. The determination of the plurality of alternative first partial process chains for the first resource entity also can be referred to as a solution to a first optimization problem.

In a subsequent step, at least one second partial process chain for the second resource entity is determined for each of the first partial process chains that is determined. In the aforementioned example of harvesting machines as the first resource entity, at least one second partial process chain for a transfer vehicle is now determined, in a subsequent step, for the various possible driving tracks of the harvesting machines and resultant various location-time points for transferring the crop to such a transfer vehicle, i.e., a time-dependent path for the transfer vehicle is determined.

Input quantities for this step to determine the second partial processes are preferably the solution space for the first optimization problem, i.e. the plurality of alternative first partial process chains, and the information on field geometry (outer field limits, obstacles on the field or on access paths, the position and nature of access paths and field access points, soil properties, requirements for soil conservation/compression, drilling direction, etc.) used for the first optimization problem. Basic technical data (machine parameters of the machines that are used) are preferably used as well for the second resource entity. The first partial process chains that are determined also define, in particular, the possible solution space for the second partial process chains, for example, by determining the field regions that were harvested at a certain point in time and are therefore preferably driveable.

The combination of each of the alternative first partial process chains with the particular associated second partial process chain therefore results in a plurality of total process chains. The plurality of total process chains contains solutions that would not be determined in hierarchical planning, for instance, because they are based on a first partial process chain that yields poorer outcomes for a certain criterium than does another first partial process chain, for example. Second (and, possibly, third and further) process chains also are determined for the first partial process chains that are less advantageous at first glance, and are combined to form total process chains. As a result, a total process chain comprising a less advantageous first partial process chain and an advantageous second partial process chain can therefore yield a better solution overall than would the combination of an advantageous first partial process chain and a less advantageous second partial process chain. This is because the advantageous second partial process chain is not possible for the advantageous first partial process chain.

The approach avoids the problem that disadvantages and suboptimal solutions related to subsequent partial process chains must be tolerated due to an early selection of a certain partial process chain. In contrast to known hierarchical planning methods, the planning method presented here can result in better overall results with consideration for the technical interactions between the various machines.

After the alternative first partial process chains for the first resource entity are combined with the particular associated, at least one second partial process chain for the second resource entity to form a plurality of total process chains, one of the total process chains is selected. The total process chain or a part thereof that is relevant to a particular machine, or relevant information is preferably transferred to the machines of the first and/or second resource entity.

The inventive method therefore combines three planning methods, namely static preplanning, planning the first resource entity and planning the second resource entity. The steps building upon the static preplanning preferably take place during the running time, i.e., during the work operation. This has the advantage that the current situation and resultant basic conditions are taken into account in the planning during the work operation.

A further important advantage of the method is that it is possible to determine a total process chain for complex agricultural applications that was optimized according to one criterium or preferably several criteria. It is particularly advantageous, for example, to determine the most cost-favorable process chain that results from the partial process chains that are identified. In this manner it also is possible to achieve an overall increase in the efficiency of the process chain for an agricultural operation.

The method also achieves the aforementioned advantages, in particular, when not only second partial process chains but also third or further partial process chains are determined in further steps for third or further resource entities. It is preferable for a plurality of alternative partial process chains of the subsequent step to be determined in the second, third or further partial process chains for each of the alternative partial process chains of the preceding step.

The further resource entities can exert great influence on the total processes. For example, transfer times can be minimized by ensuring that the transfer vehicle and the road hauling vehicle are aligned with one another in terms of fill quantity, since the road hauling vehicle would only need to be brought alongside once to be filled completely. The aligned fill quantity must be accounted for at the point when the transfer vehicle is loaded by the combine harvester, however. It is therefore preferable that technical conditions or advantageous parameters of the subsequent resource entities, such as fill quantities of the hauling vehicles to be reached, also be taken into account as input quantities to determine the particular partial process chain.

If a resource entity contains immobile or semi-mobile resources, a movement plan is not created in the determination of partial process chains. Instead, results that are appropriate for the particular resource type are determined, which, in turn, can influence other partial process chains, more particularly other resource entities. For example, the number, position, accessibility and available capacity of silos or storage facilities can influence the movement plan for the hauling vehicles, or silos or storage facilities can be filled differently due to fill level forecasts.

The method also is advantageous in that it requires little computing power and computing time, in the embodiments described in the following as well, since it must be suitable for the application in which it is used on agricultural machines, e.g., harvesting machines to be used in the operation, and for the planning carried out while the process is underway.

The method can be further developed in that each of the alternative first partial process chains contains motion parameters, e.g., ground speed and/or steering motions, for the machines of the first resource entity, and/or each of the second partial process chains for the second resource entity contains motion parameters, e.g., ground speed and/or steering motions, for the machines of the second resource entity.

In this embodiment, the results of the first and/or second partial process chains contain not only the interlinked driving tracks and certain location/time points to be reached, e.g., rendezvous positions for unloading the grain tank between the harvesting vehicle and the transfer vehicle, but also motion parameters for the particular machines, e.g., ground speed and/or steering motions.

A problem with existing planning methods that do not determine such motion parameters is, for example, that standstill times occur because a machine was driven to the position to be reached at a higher speed than was necessary. In addition to the standstill time, use of such known planning methods also results in higher costs due to the higher fuel consumption and greater wear that occur at higher speeds. When the preferred determination of motion parameters is carried out, however, motion parameters can be specified for the paths to be covered, and for path sections in particular, such as ground speeds and/or steering motions that are required in order to reach a certain position at a certain time while simultaneously reducing the fuel consumption and/or wear of the machine and/or unwanted soil compression or other unwanted side effects. The definition of different motion parameters for path sections is preferred when the conditions on various path sections differ, e.g. when the path sections extend across different terrain.

The determination of motion parameters, for path sections as well, is advantageous when replanning or new planning is carried out during an on-going agricultural operation, e.g., due to the basic conditions changing. A basic conditions change might include obstacles appearing in the field or on access paths, unexpected changes in the weather, machine stoppages due to disruptions of the work process (due, for example, to rocks in the field or a clogged header) or maintenance work. In this case, the advantageous motion parameters usually change as well as a result of the new planning or replanning. The determination of changed motion parameters makes it possible to obtain a more advantageous overall process in situations in which replanning or new planning is carried out when an operation has already been partially completed.

The first and/or second partial process chains also contain interaction parameters, such as transfer quantities or fill levels or fill level ranges. This is preferred in particular when, for example, the grain-tank unloading times and the fill quantities to be unloaded are determined in terms of the maximum fill capacity of the road hauling vehicles.

The method can be further developed in that basic technical conditions of individual machines, such as possible steering angle settings depending on the speed and/or interaction conditions between the resource entities, are taken into account in the determination of the first and/or second partial process chains of the motion parameters.

In this development, relevant machine parameters such as kinematic and dynamic basic conditions are taken into account in the planning of the applicable partial process chains. This is carried out with the objective of preventing solutions from being generated that are technically unfeasible. Machine parameters such as possible steering angle settings depending on the ground speed, or permissible operating states, are taken into account in the planning of the motion parameters such as ground speed and/or steering motions.

Additional restrictions on the interaction between resource entities can result, for example, that the transfer vehicle and the harvesting vehicle must travel in parallel, at the same speed and in the same direction while the grain tank is unloaded. It is also preferable to account for interaction parameters such as transfer quantities or fill levels or fill level ranges, for example. By accounting for these basic conditions, it is ensured that the partial process chains that are determined can also be implemented by the particular resource entities without technical problems or leaving specified operating states.

The method can be further developed in that the first and/or second partial process chains and/or the total process chains can be assigned values for a plurality of criteria, which are preferably weighted.

In this development, a plurality of criteria that show how preferable a solution is from various perspectives is taken into account. Planning based on multiple criteria is made possible in this manner, which, compared to existing methods that utilize only one (optimization) criterium, leads to improved planning results that come closer to optimal total productivity in particular. According to the embodiment, the first and/or second partial process chains and/or the total process chains are assigned values for the different criteria that preferably indicate whether a criterium is met well or less well. Since the different criteria can vary in terms of significance, these criteria are preferably weighted. For example, the criteria can be weighted in a user-specific manner since different weightings may be required for different, user-specific application situations.

Preferred criteria can be, for example: standstill times, capacity utilization, wear (due, for example, to driving routes transversely to the drilling direction or on unfavorable terrain), fuel consumption, time requirements, route, soil compression, destruction of the stand (caused, for example, by the stand being traversed by a transfer vehicle), grain tank fill levels, number of grain tank unloading processes or hauling trips required, yield quantity, crop quality (losses, silo compression, for example) and losses due to loading.

Preferably, the weighting of the criteria also can be changed during the running time, i.e., during the operation, thereby yielding new or changed results when new planning or replanning takes place while a process is underway.

The method can be further developed in that all values are converted to a common comparison scale and one total value is defined for each first and/or each second partial process chain and/or each total process chain, preferably via addition of the converted values and, possibly, via multiplication by weighting factors of the criteria.

The values are converted to a common scale in order to make it possible to compare the values across the various criteria and, therefore, to perform an overall evaluation of the different solutions. Costs can be used as a common comparison scale. It is therefore preferable to convert the values in the various criteria into cost values using cost functions. Such costs are, for example, the costs per liter of fuel and the hourly machine operating rates. One possible way to weight the criteria is to multiply the cost values by the weighting factor. The particular cost functions for the various criteria are preferably likewise specifications or input quantities for the determination of the first and/or second partial process chains and/or the total process chains. The results of the particular determination steps, therefore, also contain values that have preferably been converted to costs. One total cost value across all criteria is determined for every first and/or second partial process chain and/or every one of the total process chains, preferably via addition of individual values in the various criteria, which may have been weighted via multiplication by weighting factors. The total cost values of the first and particular associated second partial process chains are added to form one total cost value for the particular total process chain.

The optimum of a single resource, such as the maximum capacity of the machine operated at the highest hourly rate, therefore does not determine how the work process is carried out. Instead, it is possible to plan the process and evaluate the plan results based on multiple criteria. For example, if criteria were weighted accordingly, the objective of a chopping chain would no longer be to ensure that the forage harvester is always operated at full capacity (singular criterium: maximum utilization of the most expensive resource), but rather to ensure that compression in the silo takes place in an optimal manner with consideration for the costs incurred (objective based on multiple criteria: good silo compression at low total costs). Another example is that of achieving low total process costs in a short total processing time and with a defined crop quality while considering, for example, the costs to haul the crop to the silo instead of considering only the standstill times of the combine harvesters.

Converting all values to a common comparison scale, for example, by performing the conversion into cost values using cost functions, utilizing costs as the comparison scale, results in the advantage that a plurality of criteria can be taken into account and that the total process chain can be easily optimized by using the comparison scale. Such operation makes it possible to select the solution that is most cost-effective overall, in which a plurality of (possibly weighted) criteria was taken into account via the conversion using cost functions. In this manner, it also is possible to determine a total process chain that represents the most cost-favorable solution overall (preferably with consideration for a plurality of criteria), for complex agricultural applications as well. The efficiency of the total process chain for an agricultural operation in particular can therefore be increased in an advantageous manner.

The method can be further developed in that making a selection of one of the total process chains includes comparing the total values of the total process chains.

By comparing the total values of the total process chains, it is possible to select a total process chain that represents the best solution with consideration for a plurality of criteria. When a conversion into total cost values is carried out using cost functions in particular, it is possible to select a total process chain that is close to the productivity optimum.

The invention can be further developed in that the time required to determine the first partial process chains and/or the second partial process chains is reduced by utilizing preferred solution patterns.

In this development, the time required to determine the partial process chains is reduced, preferably by utilizing certain procedures, such as accessing rules or “rules of thumb” that have proven effective in practical technical application. For the step of determining the preferably first partial process chains, it is possible to utilize route plans for certain field areas that have proven effective in the past or that have been theoretically preplanned, for example, when harvesting vehicles are involved. Subdividing large field areas into a plurality of subareas also can result in a faster solution. Rules or estimations that have proven effective in practical application can be used to reduce the effort required to determine the costs for the partial process chains.

One example of a possible rule is that the combine harvesters should travel in a group if possible, i.e., they should not exceed a certain maximum separation from one another (exceptions are allowed when making the first cut, for example), to ensure that the transfer vehicle does not need to travel long distances between the combine harvesters. Another example is a method for adapting the working width, in which the driving tracks are planned in such a way that (at least in subsections of the field) narrower strips are harvested (with 85% minimum working width of a harvesting machine, for example). It is therefore possible to prevent a narrow strip of the stand from remaining at the end due to the field geometry, in which case it would not be possible to utilize the full working width of the harvesting machine. The method of adapting the working width therefore results in better utilization of the capacity of the harvesting machines.

The method can be developed by reducing the quantity of alternative first partial process chains, preferably according to predetermined filters.

One preferred possibility for reducing the time required for planning is to reduce the plurality of first partial process chains that are determined by ruling out solutions that would not result in a valid solution or would result in a disadvantageous solution of the second partial process chains. To this end, the first partial process chains that have already been determined are preferably checked according to predetermined filters and only the first partial process chains having certain properties are taken into account as the basis for determining the second partial process chains.

One example thereof is to check the result on the basis of a so-called transfer corridor to determine whether it is a solution that can be implemented by the transfer vehicle. The transfer corridor is the region of a field in which the last grain-tank unloading process of a combine harvester must take place before the transfer vehicle leaves the field and is itself unloaded there. This transfer corridor is defined by the geometry of the field and the access points thereof and can be statically calculated. This procedure makes it possible to rule out many solutions for the first partial process chains that were determined without the need to determine the associated second partial process chains (which requires complex calculation).

The method is further developed using a method to determine the first partial process chains and/or the second partial process chains that can be aborted at any point in time or at a predetermined point in time and that delivers an optimization result determined up to this point in time.

In order to determine the second partial process chains, in the example of planning the routes for the transfer vehicles, it is advantageous to select an algorithm that can be interrupted at any time and that outputs an optimum that was calculated up to this point in time (i.e., a so-called anytime algorithm).

The method simultaneously makes it possible to also optimize the separate steps of the determination of the first and second partial process chains separately from one another in terms of the time required to implement them. That is, since the first and second partial process chains can be partial process chains for different resource entities, different possibilities for reducing the time required to carry out this step can also be selected depending on the technical properties and basic conditions thereof for determining the partial process chains.

The method therefore makes it possible to simultaneously achieve the contradictory objectives of planning more precisely and more quickly adapting the plan while the process is underway, i.e., to shorten the time required to carry out the planning.

The method can be further developed by including steps to determine the first and second partial process chains, to combine them and to select one total process chain are continuously repeated during the operation, wherein the time required to perform the steps is preferably less than 1 minute, in particular, less than 10 seconds

Preferably, the steps to determine the first partial process chains and the second partial process chains, to combine them to form total process chains, and to select a preferred total process chain are repeated continuously and regularly during the running time. The steps are built upon the static preplanning, and therefore a total process chain that has been optimized, possibly according to the changed conditions, is selected even if changes occur to the basic conditions or the actual states and positions of the machines, at any time, for the remainder of operation.

Since, in the case of typical agricultural operations, such as harvesting a field using combine harvesters, approximately 5 grain-tank unloading procedures can occur per hour. Hence, the time that is available for the individual processes (approaching the combine harvester, the transfer (approximately 3 minutes), possibly approaching the second combine harvester, possibly the second transfer procedure, approaching the road hauling vehicle, transfer to the road hauling vehicle (approximately 3 minutes) is short. It is preferable, therefore, for the time remaining to perform the determination of the first and second partial process chains, to combine them and select a total process chain to be less than 1 minute and preferably less than 10 seconds. In this manner, it is ensured that a suboptimal process that may have occurred due to a change in circumstances does not last too long while new planning is carried out. Instead, the times to carry out a suboptimal process are minimized by way of the new method planning requiring the least amount of time.

It also is possible within the stated times to forward the total process chain that was determined, or partial information related thereto, to the individual machines, preferably via wireless transmission, to display it there and/or to use it to for machine control.

In one embodiment, the method comprises the following steps:

transferring data on the total process chain or a part thereof that is relevant for the particular machines, in particular the motion parameters for the particular machine, to at least one of the machines and controlling an actuator system (for example, to control the ground speed and/or the steering motions) of this at least one machine on the basis of the transferred data.

The results of the total process chain that was determined, or at least parts thereof such as the information that is relevant for a single machine, are preferably transferred to the particular machines and are used there to control the machine.

The control preferably takes place automatically, semi-automatically or manually. For example, the transmitted data can be used directly to control the machine without user intervention. The data and, possibly, preferable machine parameters or motion parameters derived therefrom, such as ground speed and/or the steering motions, also can be displayed to an operator via a visual display or a human-machine interface. Such display enables the operator to control the machine accordingly. In a combined form, it also is possible for the automatic control to be displayed to an operator on a visual display or a human-machine interface and for the operator to manually intervene if he/she prefers a different control or if he/she notices an unexpected obstacle.

The invention also includes an arrangement for carrying out the method that comprises 1 to m external systems, each having one data base and one program logic, 1 to n machine systems, each having one fieldwork computer, a human-machine interface and a communication device, preferably a radio communications device, data connections, preferably wireless data connections, between the external systems and the machine systems. Such arrangement is designed to determine and implement an optimized total process chain using a method according to one of the preceding claims.

The arrangement can be further developed in order to carry out the method according to the invention, and the developments thereof. With respect to the embodiments, specific features, variants and advantages of the arrangement and the developments thereof, reference is made to the description, above, of the corresponding method features.

### BRIEF DESCRIPTION OF THE DRAWINGS

Further features and advantages of the invention will become apparent from the description of embodiments that follows, with reference to the attached figures, wherein:

FIG. 1: shows a schematic representation of the input quantities, execution and results of the method and the work operation;

FIG. 2: shows a schematic flow chart of the method;

FIG. 3: shows a schematic representation of the first partial process chains, second partial process chains and the combined total process chains that were determined using the method, and the selected total process chain in the case of two resource entities,

FIG. 4: shows a schematic representation of first, second and third partial process chains that are determined, the combination thereof to form total process chains and a selected total process chain in the case of three resource entities; and

FIG. 5: a schematic representation of an arrangement for carrying out the method according to the invention.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

The implementation of the method will be described in the following by reference to the harvesting of a field using combine harvesters, wherein the crop is brought to storage facilities or silos using transfer vehicles and road hauling vehicles. The exemplary method described in the following can also be applied to other agricultural operations, however, such as harvesting a field using forage harvesters or, for example, depositing fertilizer or seeds on a field.

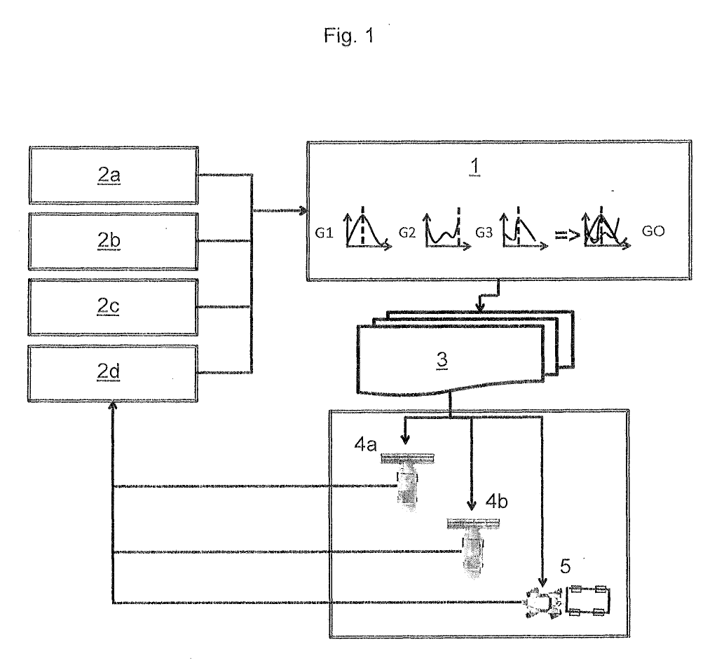

FIG. 1 shows a schematic representation of the input quantities, the execution and the results of the method and the work operation. In the example shown therein, the input quantities are environmental information 2a (field limits, crop properties, for example), machine properties or parameters 2b (installed capacity, for example), external services 2c (weather data for example) and sensor data 2d (position, crop properties, for example) of the resources. In the example, a total process chain is selected (which will be described in greater detail in the following) by way of the method 1 using the input quantities 2a, 2b, 2c, 2d, and machine-relevant information 3 on the total process chain is transmitted to two combine harvesters 4a, 4b of a first resource entity and to a transfer vehicle 5 of a second resource entity. The data acquired by the machines 4a, 4b, 5 can be acquired, in turn, as sensor data 2d and used as input quantities for the method 1 (for new planning or replanning, for example). The method 1 accounts for optima G1, G2, G3 of individual resources and determines a total process chain GO that has been optimized in terms of multiple criteria.

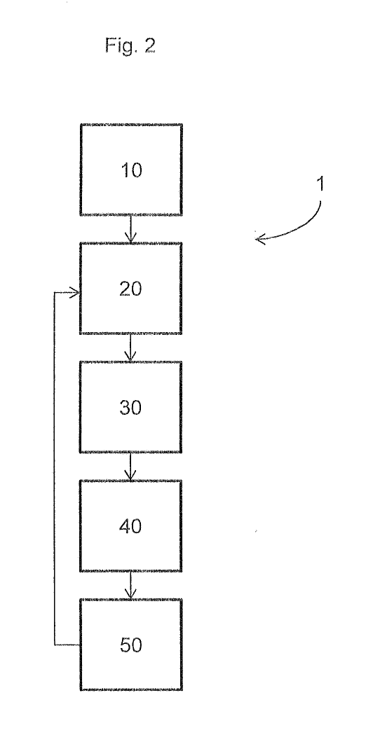

The method 1 can take place as follows. First, in step 10 according to FIG. 2, static preplanning is carried out with determination of the number of machines in the first and second resource entity to be used. Therein, the usage time frame, the type of utilization and the field area to be worked are taken into account. A method according to the first three steps of the method described in paragraphs 22 to 35 of DE 10 2008 050 460 A1 can be used for the static preplanning.

Building upon the static preplanning, the further planning steps now take place. Step 20 includes determining a plurality of alternative first partial process chains for the first resource entity. Steps 30 includes determining at least one second partial process chain for the second resource entity for each of the alternative partial process chains for the first resource entity. Step 40 includes combining the alternative first partial process chains for the first resource entity with the respective associated at least one second partial process chain for the second resource entity to form a plurality of total process chains. Step 50 includes selecting one of the total process chains while the work operation is underway.

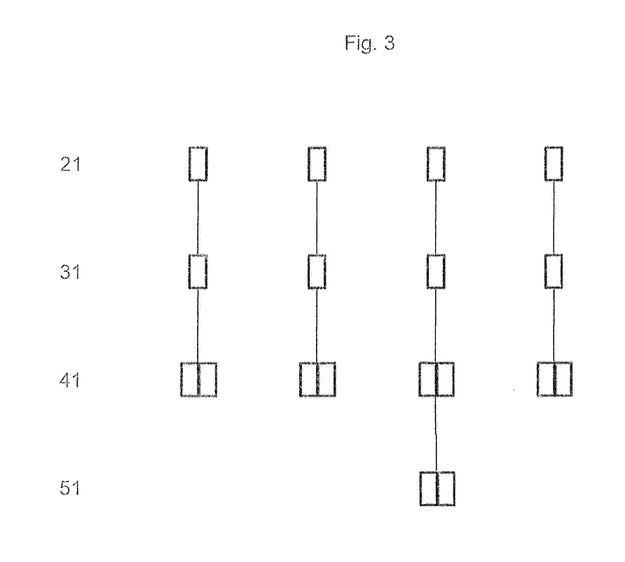

A plurality of partial process chains 21 is thereby determined in step 20, as shown in FIGS. 2 and 3. In step 30, a second partial process chain 31 is selected for each of the first partial process chains 21, which are combined in step 40 to form total process chains 41. One total process chain 51 is selected from total process chains 41 in step 50.

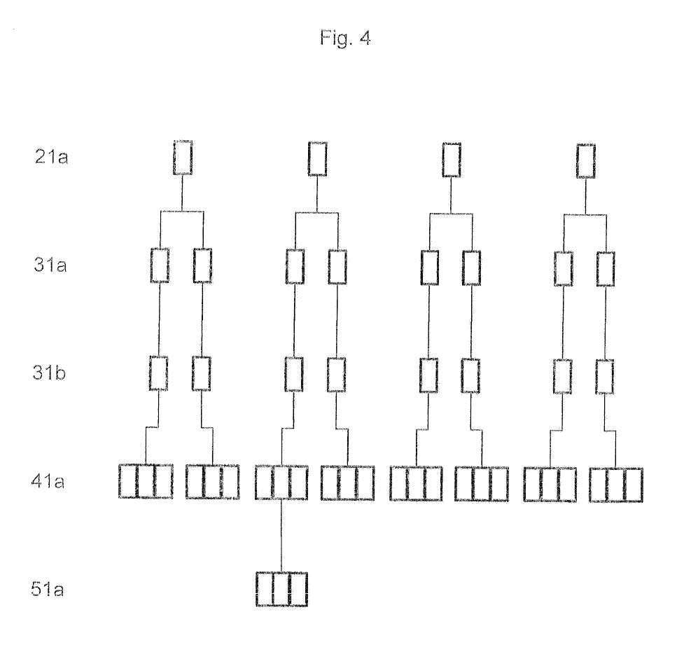

The corresponding method is depicted in FIG. 4 for three resource entities. Therein, a plurality (two in each case here) of second partial process chains 31a is determined for a plurality of first partial process chains 21a, and at least one third partial process chain 31b is then determined for each of the second partial process chains 31a. The first, second and third partial process chains 21a, 31a, 31b are then combined to form total process chains 41a and one advantageous total process chain 51a is selected.

Preferably, one task of the method 1 is to implement the motion planning 3 of a plurality of cooperating agricultural machines 4a, 4b, 5 that are coupled to one another via spatial and time-related constraints. The solution found by way of the method 1 is preferably based on a plurality of different criteria.

Building upon static preplanning 10, steps 20 to 50 are planned while the process is underway. The planning problem solved by the invention is highly complex due to the spatial and time-related constraints thereof. It is therefore advantageous to carry out the motion planning of combine harvesters 4a, 4b and transfer vehicles 5, for example, in two separate steps 20, 30 or two optimization problems O1 and O2.

For the optimization problem O1 (motion planning of the combine harvesters 4a, 4b), the following input data, inter alia, are preferably provided: *geometry of the field to be worked (outer field limit, obstacles, drilling direction, field access points), number and type of vehicles participating (including relevant machine parameters such as kinematic and dynamic basic conditions, capacity, unloading performance, working width and harvesting output), cost factors for criteria such as distance, time and fuel.

To solve the optimization problem, a search graph is preferably created in which a preferred direction is generated on the basis of heuristics. The result of O1 is preferably a search graph comprising a plurality of alternative first partial process chains 21, each of which preferably contains the following information: interlinked driving tracks for each participating combine harvester and specifications for the time-dependent position of the combine harvesters, position of the transfer windows that must be reached by the transfer vehicle, crop quantity to be transferred, motion parameters, preferably such as ground speed and/or steering motions, costs of the solution.

For the optimization problem O2 (motion planning for the transfer vehicle), the following input data, inter alia, are preferably provided: result of the O1 (plurality of first partial process chains), geometry of the field to be worked (areas worked at a certain point in time, outer field limit, obstacles, drilling direction, field access points), number and type of participating transfer vehicles (including relevant machine parameters such as kinematic and dynamic basic conditions, capacity, unloading performance), cost factors for criteria such as distance, time and fuel, capacities available at the edge of the field:

The result of O2 (second partial process chains 31) can be a search graph with solutions, for instance, each of which preferably contains the following values: Time-dependent paths for transfer vehicles, crop quantity to be transferred, motion parameters, preferably such as ground speed and/or steering motions, costs of the solution.

In order to find a total process chain that has been optimized according to the defined criteria, the particular first and associated second partial process chains 21, 31 are combined to form total process chains 41 and the total cost values of the total process chains 41 also are formed. To this end, the values in the criteria are preferably converted to a comparison scale using conversion functions, preferably cost functions. By comparing the total costs of all total process chains 41, it is possible to select a total process chain 51 that is optimized in terms of multiple criteria.

Converting all values using cost functions into cost values while using costs as the common comparison scale advantageously makes it possible to take a plurality of criteria into account. A further advantage results in that the total process chain can be easily optimized by reference to the comparison scale, thereby making it possible to select the most cost-favorable solution. It is therefore also possible to determine a total process chain having greater efficiency and minimized costs for complex agricultural applications.

Since the basic conditions of work operations can differ greatly (with respect to available resources, cultivated crops, market prices, fuel prices, for example) the criteria can preferably be weighted individually. It is therefore possible to generate user-specific planning results.

The weighting of the criteria also can be changed during the running time and therefore yield new or changed planning results. For example, a harvesting process is started with the goal of minimizing costs. If the forecast calls for a change in the weather, the field must be harvested as quickly as possible while the process is carried out. As a result, the criterium “time” is given higher priority and a new plan is created for the process running time, and the resources then follow this new plan.

Despite the separation of the method into two optimization problems, constraints such as the size of the field or the number of machines used can render it impossible for the calculation of all combinations of the two optimization problems to be implemented in a reasonable amount of time. This is due mainly to the fact that new planning in the process becomes necessary over the short term due to dynamic changing environmental conditions such a fluctuating yield.

The following preferred measures can therefore be integrated in order to reduce the amount of computing time required. The need to use these methods depends on the complexity of the problem, the available computing time, the dynamics of the planning and the computing capacity that is available. The planning method also can be used without these methods. It must be taken into account that implementation of the measures may not result in the optimum calculated as possible being reached.

For the first optimization problem (the determination of the first partial process chains), the search problem can be reduced, for example, by using route plans on field areas that are common in practice. Alternatively or additionally, if the field is large and the number of driving tracks is therefore great, the problem can be subdivided into equivalent problems by subdividing the bed.

The total method also can be shorted, preferably, by carrying out a check to determine whether a first partial process chain is involved, the location-time points of which for unloading can be reached by a transfer vehicle (i.e., the so-called possible transfer corridor). The transfer corridor is the region of a field in which the last grain-tank unloading process of a combine harvester should take place before the transfer vehicle leaves the field and is itself unloaded there. This transfer corridor is defined by the geometry of the field and the access points thereof and can be statically calculated. This procedure makes it possible to rule out many first partial process chains for which the second partial process chains must be determined, in a computationally complex manner.

For the second optimization problem (the determination of the second partial process chains), only a portion of all possible solutions can be calculated. So-called anytime algorithms, such as Anytime A*, are used here, in order to find a result that is optimal for this time within the amount of time known to be available.

One possible approach in practical application can be summarized as follows, in an overview:
1) Determine all solutions to the first optimization problem (the first partial process chains), using preferred measures for reducing the computing time.
2) Filter these solutions, if necessary, by ruling out first partial process chains that require transfer corridors that cannot be achieved.
3) Form a subquantity of the solutions to the first optimization problem (of the first partial process chains) having the lowest costs (across a plurality of criteria by converting the values into costs). The number of solutions depends on the computing time that is available to the planning system.
4) Solve the second optimization problem for this subquantity, that is, determine the associated second partial process chains.
5) The combination of the total costs of the combined first and associated second partial process chains results in the optimized total solution, that is, the total process chain.

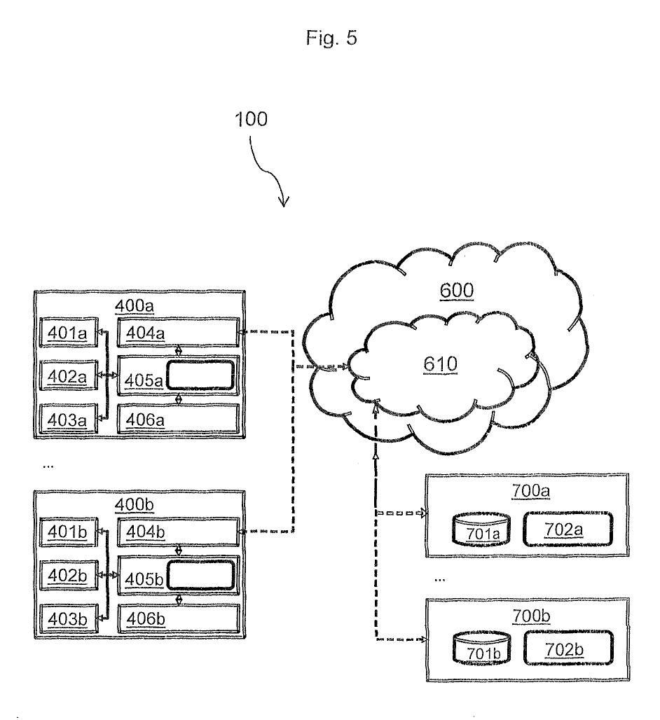

FIG. 5 shows an exemplary arrangement 100 for carrying out a method 1 according to the invention. The system architecture 100 that is shown comprises technical means for implementation, which can be subdivided into means for information processing, in particular for planning, means for communication between the machines and external systems, means for receiving information on the surroundings, and means for providing external information, for providing master data and for providing historical information.

The means for information processing and planning comprise a comprehensive planning system to be reached, according to the method 1, with consideration for the available information on, for example, process states, the optimum and an optimized solution for the total process. This planning system is available in all participating machines in a distributed manner (distributed system). Differently sized portions of the plan can be implemented on each machine. It is possible, for example, for a “master machine” to exist that creates a global (i.e., comprehensive), plan for all machines that is not highly detailed. Driving tracks are roughly precalculated. Specific detailed planning is carried out on each individual machine on the basis of the rough plan, which is distributed and is updated constantly. On the basis of the roughly determined driving tracks, it determines the target route in detail that can be traveled by way of the steering.

At least one fieldwork computer 405a, 405b is provided on each machine 400a, 400b. The fieldwork computer 405a, 405b comprises at least one computer unit, at least one memory unit and at least one interface for at least one communication unit 404a, 404b. These interfaces are connected to a bus system of the machine in order to receive sensor data, to control a machine actuator system 401a, 401b, and to have connections to further control devices 402a, 402b. Furthermore, wireless communication systems and human-machine interfaces 406a, 406b such as a monitor are thereby connected.

The at least one communication unit 404a, 404b for communication between the process participants and external systems are based on wireless data connections (radio communication). Near infrared technologies such as WLAN are preferably used between the machines for this purpose, due to the bandwidth and latencies, but also due to the fact that mobile radio networks such as GSM are not always reliably available in rural areas. However, mobile radio networks such as GSM can be used here in a supporting manner. Mobile radio networks such as GSM are used primarily between machines 400a, 400b and external systems 700a, 700b due to the radio transmission range.

Building upon the communication layers made available by the radio protocols 600, a middleware 610 that takes over the communication in the distributed system is used starting at a certain layer of the OSI layer model, preferably starting at layer 5 (meeting layer). The Data Distribution Service (DDS) can be used for this purpose, for example.

The means for capturing environmental information can be sensor elements 403a, 403b that are available on the machine or that can be retrofitted thereon. Such means can be GPS systems for position determination or sensors for determining throughput quantities, for example.

The means 700a, 700b for providing external information (external systems), for providing master data and for providing historical information are preferably data base systems 701a, 701b, that ensure the persistence of data such as machine data or field data. Alternatively, the information also can be generated during the running time on the basis of data from various further information sources (such as weather forecasts) using a system having program logics 701a, 702b. In both cases, the systems that provide these information services can be reached by the planning system via the available communication means, preferably during the running time.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method (1) for planning a process chain for an agricultural operation comprising a first resource entity of a first type of agricultural machines (4a, 4b), such as combine harvesters or forage harvesters, and a second resource entity of a second type of agricultural machines (5), such as hauling vehicles, comprising the steps of:
determining (10) a number of machines in the first and the second resource entity to be used in the agricultural operation depending on a usage time frame, a type of operation and a field area to be worked;
determining (20) a plurality of alternative first partial process chains (21, 21a) for the first resource entity;
determining (30) at least one second partial process chain (31, 31a) for the second resource entity for each of the alternative first partial process chains (21, 21a);
combining (40) the alternative first partial process chains (21, 21a) with the particular associated at least one second partial process chain (31, 31a) to form a plurality of total process chains (41, 41a); and
selecting (50) one (51, 51a) of the total process chains.

2. The method (1) according to claim 1, wherein each of the alternative first partial process chains (21, 21a) contains motion parameters, such as ground speed and/or steering motions for the machines (4a, 4b) of the first resource entity and/or each of the second partial process chains (31, 31a) for the second resource entity contains motion parameters, such as ground speed and/or steering motions, for the machines (5) of the second resource entity.

3. The method (1) according to claim 1, wherein the steps of determining the first or the second or both partial process chains (21, 21a, 31, 31a) of the motion parameters further comprise taking into account basic technical conditions of individual machines (4a, 4b, 5), such as possible steering angle settings depending on the speed or interaction conditions between the resource entities or both.

4. The method (1) according to claim 1, further comprising assigning values in a plurality of criteria to the first or second partial process chains (21, 21a, 31, 31a) and/or the total process chains (41, 41a) are assigned values in a plurality of criteria.

5. The method (1) according to claim 4, wherein all values are converted to a common comparison scale and one total value is obtained for each first or each second partial process chain (21, 21a, 31, 31a) or both and/or each total process chain (41, 41a), preferably via addition of the converted values and via multiplication by weighting factors of the criteria.

6. The method (1) according to claim 5, wherein making a selection of one (51, 51a) of the total process chains (41, 41a) includes comparing the total values of the total process chains.

7. The method (1) according to claim 1, wherein the time required for determining the first partial process chains (21, 21a) or the second partial process chains (31, 31a) or both is reduced by utilizing preferred solution patterns.

8. The method (1) according to claim 1, wherein the quantity of alternative first partial process chains (21, 21a) is reduced according to predetermined filters.

9. The method (1) according to claim 1, wherein a method used to determine the first partial process chains (21, 21a) or the second partial process chains (31, 31a) or both can be aborted at any point in time or at a predetermined point in time and that delivers an optimization result determined up to this point in time.

10. The method (1) according to claim 1, wherein the steps to determine (20, 30) the first and second partial process chains (21, 21a, 31, 31a), to combine (40) them and to select (50) one total process chain (51, 51a) are continuously repeated during the operation, and wherein the time required to perform the steps is less than 1 minute.

11. The method (1) according to claim 1, further comprising the steps of:
transferring data on the total process chain (51, 51a) or a part thereof that is relevant for the particular machines such as the motion parameters for the particular machine, to at least one of the machines (400a, 400b), and
controlling an actuator system (401a, 401b) such as the ground speed or the steering motions or both, of this at least one machine (400a, 400b) on the basis of the transferred data.

12. An arrangement (100) for carrying out the method according to claim 1, comprising:
1 to m external systems (700a, 700b), each having one data base (701a, 701b) or one program logic (702a, 702b) or both,
1 to n machine systems (400a, 400b), each having one fieldwork computer (405a, 405b), a human-machine interface (406a, 406b) and a communication device, preferably a radio communications device (404a, 404b),
data connections between the external systems (700a, 700b) and the machine systems (400a, 400b),
wherein the arrangement is determines and implements an optimized total process chain (51, 51a).

13. The method (1) according to claim 4, wherein the criteria are weighted.

14. The method (1) according to claim 10, wherein the time required to perform the steps is less than 10 seconds.

15. The arrangement according to claim 12, wherein the data connections are wireless data connections.
